(19) United States
(12) Patent Application Publication
(10) Pub. No.: US 2023/0196627 A1
(43) Pub. Date: Jun. 22, 2023

(54) ANTI-ALIASING BY ENCODING PRIMITIVE EDGE REPRESENTATIONS

(71) Applicant: META PLATFORMS TECHNOLOGIES, LLC, Menlo Park, WA (US)

(72) Inventor: Larry Seiler, Redmond, WA (US)

(21) Appl. No.: 17/553,678

(22) Filed: Dec. 16, 2021

(51) Int. Cl. G06T 9/20; G06T 19/20

(52) U.S. Cl. CPC G06T 9/20; G06T 19/20

(57) ABSTRACT

A method by a computing system of a device includes generating a plurality of fragments by rasterizing one or more geometries to be displayed by a set of pixels. A pixel of the set of pixels is associated with fragments of the plurality of fragments, each including edges covering at a least a portion of the pixel. The method further includes encoding each of the fragments to include a representation of the one or more edges, including (1) an orientation of the edge and (2) a pixel coverage associated with the edge. The method further includes determining one or more alpha values corresponding to the fragments based on the orientation and the pixel coverage associated with each of the one or more edges. The method thus includes generating a color value for the pixel based on the one or more a alpha values corresponding to the fragments.

### TECHNICAL FIELD

This disclosure relates generally to anti-aliasing, and, more particularly, to anti-aliasing by encoding primitive edge representations.

### BACKGROUND

Aliasing artifacts include high-frequency artifacts, which may become apparent as jagged or staircasing lines along one or more edges of a 3D polygon or other geometry in augmented reality (AR) or virtual reality (VR). For example, when a 3D scene is rendered onto a pixel grid of a display, each pixel may be colored according to whether or not the pixel is covered by a polygon or other geometry within the 3D scene. However, for pixels that are only partially covered and occurring along the edges of the polygon or other geometry, if anti-aliasing (e.g., adjusting the pixel color according to the amount of pixel coverage) is not deployed, the partially covered pixels may become apparent as jagged or staircasing color transitions between the edge of the geometry and the background due to, for example, considering only whether the center of the pixel is covered by the geometry and not considering the degree of partial coverage of the pixel. Additionally, utilizing conventional full-scene anti-aliasing (FSAA) techniques, such as multisample anti-aliasing (MSAA), may require from 16 color samples per pixel up to 64 color samples per pixel to completely eliminate aliasing artifacts. Such conventional techniques may thus prove computationally expensive. It may be useful to provide improved anti-aliasing techniques.

### SUMMARY OF PARTICULAR EMBODIMENTS

The present embodiments are directed toward techniques for performing anti-aliasing by encoding primitive edge representations. In particular embodiments, a computing system of a device may generate a number of fragments by rasterizing one or more geometries to be displayed by a set of pixels. In particular embodiments, a pixel of the set of pixels may be associated with one or more fragments of the plurality of fragments, in which the one or more fragments may each include one or more edges covering at a least a portion of the pixel. In particular embodiments, the computing system of the device may then encode each of the one or more fragments to include a representation of the one or more edges. In particular embodiments, the representation may include, for each of the one or more edges, (1) an orientation of the edge and (2) a pixel coverage associated with the edge. For example, in particular embodiments, the computing system of the device may encode each of the one or more fragments to include the representation by encoding, for each of the one or more edges, one or more values specifying a correlated pixel coverage associated with the edge.

In particular embodiments, the computing system of the device may also encode each of the one or more fragments to include the representation by encoding, for each of the one or more edges, one or more values specifying a correlated pixel coverage associated with the edge. In particular embodiments, the computing system of the device may further encode each of the one or more fragments to include the representation by encoding, for each of the one or more edges, one or more values specifying a correlated pixel coverage associated with the edge. In particular embodiments, the computing system of the device may then determine one or more alpha values corresponding to the one or more fragments based on the orientation and the pixel coverage associated with each of the one or more edges. For example, in particular embodiments, the computing system of the device may determine the one or more alpha values by determining a near alpha value and a far alpha value corresponding to the one or more fragments.

In particular embodiments, the computing system of the device may then generate a color value for the pixel based on the one or more alpha values of the one or more fragments. For example, in particular embodiments, the computing system of the device may generate the color value for the pixel by merging together at least a first fragment and a second fragment of the one or more fragments. In particular embodiments, the computing system of the device may also generate the color value for the pixel by blending a first color and a second color respectively associated with the one or more fragments. Thus, in accordance with the foregoing embodiments, the present embodiments may provide techniques for performing anti-aliasing by encoding primitive edge representations. Indeed, the present embodiments may provide techniques to perform efficient anti-aliasing by storing a simplified representation of the primitive fragment edges that pass through a pixel while also reducing impact processing and memory resources.

The embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A and 1B illustrate examples of an extended reality (XR) system.

FIG. 2 illustrates a block diagram of a graphics rendering pipeline for performing anti-aliasing by encoding primitive edge representations.

FIGS. 3A-3D illustrate one or more running examples for performing anti-aliasing by encoding primitive edge representations.

FIG. 4 illustrates is a flow diagram of a method for performing anti-aliasing by encoding primitive edge representations.

FIG. 5 illustrates an example network environment associated with a social-networking system.

FIG. 6 illustrates an example computer system.

### DESCRIPTION OF EXAMPLE EMBODIMENTS

Aliasing artifacts include high-frequency artifacts, which may become apparent as jagged or staircasing lines along one or more edges of a 3D polygon or other geometry in augmented reality (AR) or virtual reality (VR). For example, when a 3D scene is rendered onto a pixel grid of a display, each pixel may be colored according to whether or not the pixel is covered by a polygon or other geometry within the 3D scene. However, for pixels that are only partially covered and occurring along the edges of the polygon or other geometry, if anti-aliasing (e.g., adjusting the pixel color according to the amount of pixel coverage) is not deployed, the partially covered pixels may become apparent as jagged or staircasing color transitions between the edge of the geometry and the background. Additionally, utilizing conventional full-scene anti-aliasing (FSAA) techniques, such as multisampling anti-aliasing (MSAA) or super-sampling anti-aliasing (SSAA), may require from 16 color samples per pixel up to 64 color samples per pixel to completely eliminate aliasing artifacts. Such conventional techniques may thus prove computationally expensive. It may be useful to provide improved anti-aliasing techniques.

Accordingly, the present embodiments are directed toward techniques for performing anti-aliasing by encoding primitive edge representations, in accordance with presently disclosed embodiments. In particular embodiments, a computing system of a device may generate a number of fragments by rasterizing one or more geometries to be displayed by a set of pixels. In particular embodiments, a pixel of the set of pixels may be associated with one or more fragments of the plurality of fragments, in which the one or more fragments may each include one or more edges covering at a least a portion of the pixel. In particular embodiments, the computing system of the device may then encode each of the one or more fragments to include a representation of the one or more edges. In particular embodiments, the representation may include, for each of the one or more edges, (1) an orientation of the edge and (2) a pixel coverage associated with the edge. For example, in particular embodiments, the computing system of the device may encode each of the one or more fragments to include the representation by encoding, for each of the one or more edges, one or more values specifying an uncorrelated pixel coverage associated with the edge.

In particular embodiments, the computing system of the device may also encode each of the one or more fragments to include the representation by encoding, for each of the one or more edges, one or more values specifying a correlated pixel coverage associated with the edge. In particular embodiments, the computing system of the device may further encode each of the one or more fragments to include the representation by encoding, for each of the one or more edges, one or more values specifying a correlated pixel coverage associated with the edge. In particular embodiments, the computing system of the device may then determine one or more alpha values corresponding to the one or more fragments based on the orientation and the pixel coverage associated with each of the one or more edges. For example, in particular embodiments, the computing system of the device may determine the one or more alpha values by determining a near alpha value and a far alpha value corresponding to the one or more fragments.

In particular embodiments, the computing system of the device may then generate a color value for the pixel based on the one or more alpha values of the one or more fragments. For example, in particular embodiments, the computing system of the device may generate the color value for the pixel by merging together at least a first fragment and a second fragment of the one or more fragments. In particular embodiments, the computing system of the device may also generate the color value for the pixel by blending a first color and a second color respectively associated with the one or more fragments. Thus, in accordance with the foregoing embodiments, the present embodiments may provide techniques for performing anti-aliasing by encoding primitive edge representations. Indeed, the present embodiments may provide techniques to perform efficient anti-aliasing by storing a simplified representation of the primitive fragment edges that pass through a pixel while also reducing impact processing and memory resources.

As used herein, “extended reality” may refer to a form of electronic-based reality that has been manipulated in some manner before presentation to a user, including, for example, virtual reality (VR), augmented reality (AR), mixed reality (MR), hybrid reality, simulated reality, immersive reality, holography, or any combination thereof. For example, “extended reality” content may include completely computer-generated content or partially computer-generated content combined with captured content (e.g., real-world images). In particular embodiments, the “extended reality” content may also include video, audio, haptic feedback, or some combination thereof, any of which may be presented in a single channel or in multiple channels (such as stereo video that produces a three-dimensional (3D) effect to the viewer). Furthermore, as used herein, it should be appreciated that “extended reality” may be associated with applications, products, accessories, services, or a combination thereof, that, for example, may be utilized to create content in extended reality and/or utilized in (e.g., perform activities) an extended reality. Thus, “extended reality” content may be implemented on various platforms, including a head-mounted device (HMD) connected to a host computer system, a standalone HMD, a mobile device or computing system, or any other hardware platform capable of providing extended reality content to one or more viewers. In particular embodiments, in which the HMD includes, for example, lightweight XR glasses or spectacles as opposed to more robust headset devices, the XR glasses or spectacles may, in comparison, include reduced processing power, low-resolution/low-cost cameras, and/or relatively simple tracking optics. Additionally, due to the smaller architectural area, the XR glasses or spectacles may also include reduced power management (e.g., batteries, battery size) and thermal management (e.g., cooling fans, heat sinks) electronics.

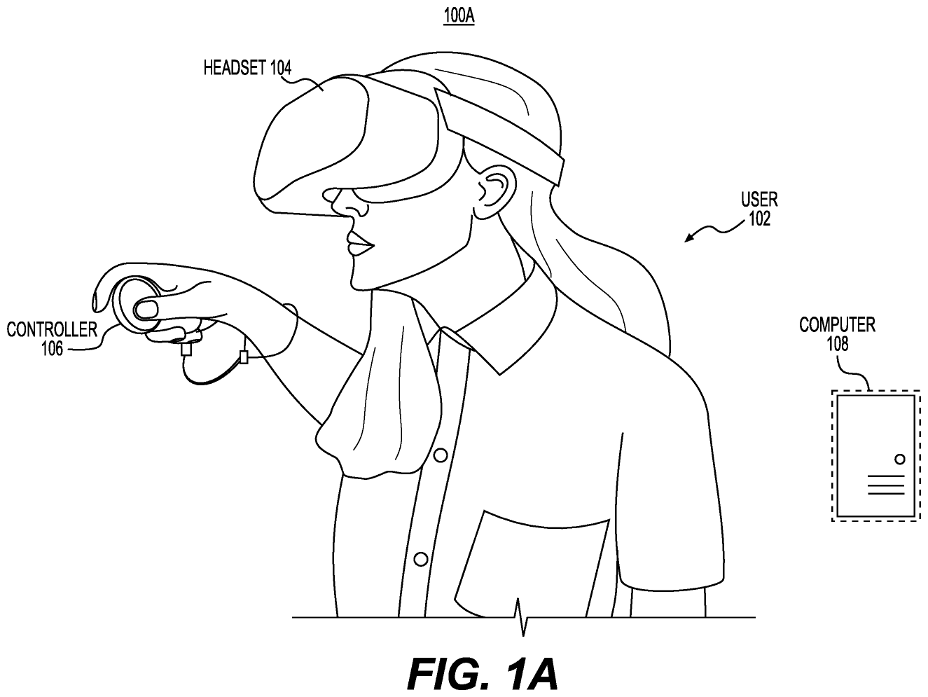

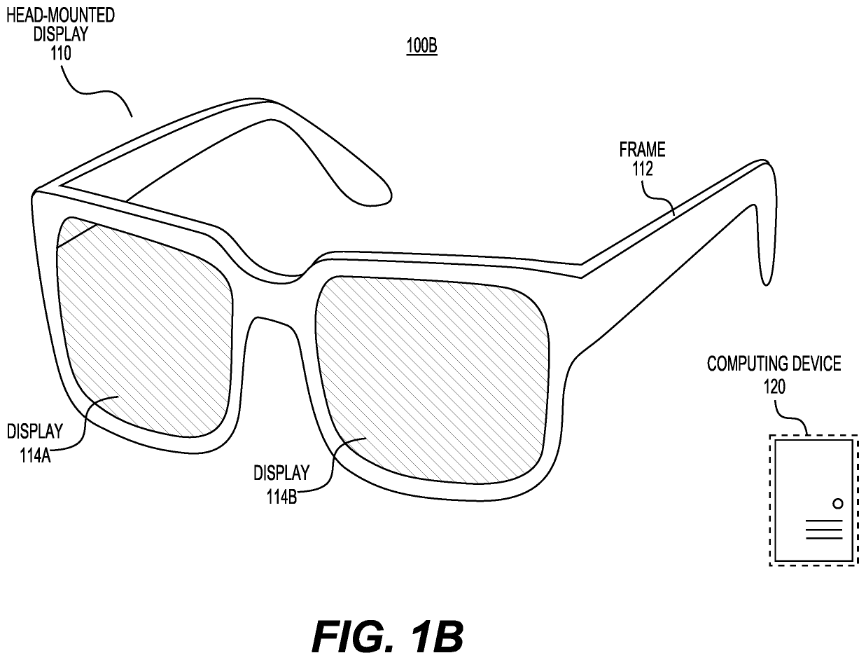

FIG. 1A illustrates an example extended reality (XR) system 100A that may be suitable for performing anti-aliasing by encoding primitive edge representations, in accordance with presently disclosed embodiments. In particular embodiments, the artificial reality system 100A may include a headset 104, a controller 106, and a computing system 108. In particular embodiments, a user 102 may wear the headset 104 that may display visual artificial reality content to the user 102. In particular embodiments, the headset 104 may include an audio device that may provide audio artificial reality content to the user 102. In particular embodiments, the headset 104 may include one or more cameras which can capture images and videos of environments. The headset 104 may include an eye tracking system to determine the vergence distance of the user 102. The headset 104 may be referred as a head-mounted display (HDM). The controller 106 may include a trackpad and one or more buttons. The controller 106 may receive inputs from the user 102 and relay the inputs to the computing system 108. The controller 206 may also provide haptic feedback to the user 102. In particular embodiments, the computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example extended reality system 100B. The augmented reality system 100B may include a head-mounted display (HMD) 110 (e.g., glasses) including a frame 112, one or more displays 114A and 114B, and a computing device 120. The displays 114A, 114B may be transparent or translucent allowing a user wearing the HMD 110 to look through the displays 114A, 114B to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The extended reality system 100B may further include a controller comprising a trackpad and one or more buttons. The controller may receive inputs from users and relay the inputs to the computing device 120. The controller may also provide haptic feedback to users. The computing device 120 may be connected to the HMD 110 and the controller through cables or wireless connections. The computing device 120 may control the HMD 110 and the controller to provide the augmented reality content to and receive inputs from users. In particular embodiments, the computing device 120 may be a standalone host computer system, an on-board computer system integrated with the HMD 110, a mobile device, or any other hardware platform capable of providing extended reality content to and receiving inputs from users.

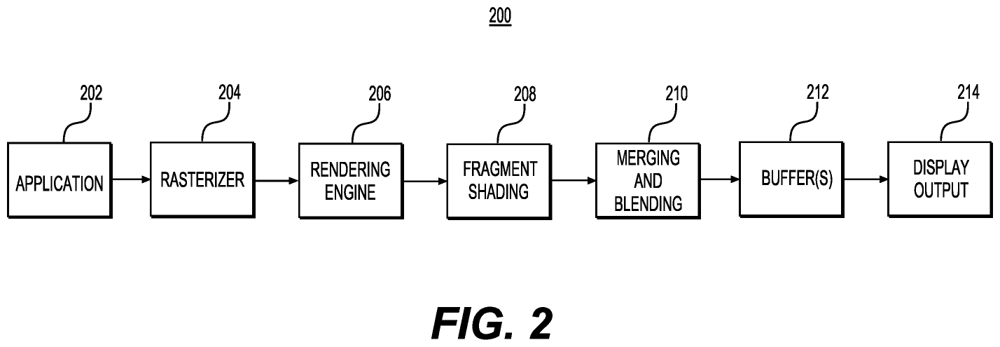

FIG. 2 illustrates a detailed embodiment of a graphics rendering pipeline 200 for performing anti-aliasing by encoding primitive edge representations, in accordance with presently disclosed embodiments. As depicted, the graphics rendering pipeline 200 may include, for example, a number of functional blocks 202-214 (e.g., a combination of one or more hardware-based and software-based functional blocks) that may be utilized to perform rendering operations and anti-aliasing operations in accordance with the presently disclosed embodiments. It should be appreciated that while the number of functional blocks 202-214 (e.g., a combination of one or more hardware-based and software-based functional blocks) may be displayed as a serial process, in some embodiments, one or more of the number of functional blocks 202-214 (e.g., a combination of one or more hardware-based and software-based functional blocks) may be performed in a different order than illustrated by the graphics rendering pipeline 200. For example, in one embodiment, fragment merging may be performed prior to fragment shading in cases, such as when two triangles join at an edge and are part of the same surface, so that the same shading operation applies to both. The benefit is to reduce the number of fragment shading operations. In particular embodiments, the graphics rendering pipeline 200 may receive frames from an application 202 (e.g., XR application) to ultimately be rendered, for example, on the displays 114A, 114B. In particular embodiments, although not illustrated, the frames received from the application 202 may be input to one or more primitive assembly functional blocks that may extract from the application 202 primitives corresponding to XR objects that may be divided into a sequence of individual base primitives (e.g., triangles or other geometries). In particular embodiments, the sequence of individual base primitives (e.g., triangles or other geometries) may be then passed to a rasterizer 204, which may be utilized, for example, to generate discrete fragments corresponding to the individual base primitives (e.g., triangles or other geometries). For example, in particular embodiments, the rasterizer 204 may extract vertices corresponding to a single primitive and transform these vertices into a set of fragments that may be mapped to one or more pixels of a particular regions of pixels of, for example, the displays 114A, 114B.

In particular embodiments, the rasterizer 204 may then pass the discrete fragments to a rendering engine 206. In particular embodiments, the rendering engine 206 may be utilized, for example, to render the respective fragments onto one or more pixels of a particular region of pixels of the displays 114A, 114B. In particular embodiments, the rendering engine 206 may provide rendered fragments to a fragment shader 208, which may be utilized, for example, to process the rendered fragments into a set of color values a depth value to be provided ultimately to a buffers 212 (e.g., one or more framebuffers). In particular embodiments, the set of color values and the depth value processed by the fragment shader 208 may be utilized to perform merging and blending. For example, in particular embodiments, the merging and blending block 210 may receive the set of color values and the depth value processed by the fragment shader 208, for example, and combine the set of color values and the depth value processed by the fragment shader 208 with color values stored by the buffers 212 (e.g., one or more framebuffers). For example, in particular embodiments, the merging and blending block 210 may be provided to combine, for example, source (e.g., application 202) and destination (e.g., display output 214) color values in various ways. In particular embodiments, all of the color values and depth value(s) may be stored to the buffers 212 (e.g., one or more framebuffers) and provided as a display output 214 to, for example, the displays 114A, 114B.

In particular embodiments, aliasing artifacts may become apparent as jagged or staircasing lines along one or more edges of a triangle or other geometry when rendered and displayed by the graphics rendering pipeline 200. For example, in particular embodiments, when a 3D scene is rendered onto the displays 114A, 114B, each pixel may be colored according to whether or not the pixel is covered by a primitives (e.g., triangles or other geometries) within the 3D scene. However, for pixels that are only partially covered and occurring along the edges of the primitives (e.g., triangles or other geometries), if anti-aliasing (e.g., adjusting the pixel color according to the amount of pixel coverage) is not deployed, the partially covered pixels may become apparent as jagged or staircasing color transitions between the edge of the geometry and the background. Additionally, utilizing conventional FSAA techniques, such as MSAA or SSAA may include from 16 color samples per pixel up to 64 color samples per pixel to completely reduce or eliminate aliasing artifacts. Furthermore, ordinary aliased rendering treats the pixel as fully covered or completely empty based on whether the center of the pixel is within the geometry, thus leading to the staircasing artifacts. Such conventional techniques may thus prove resource expensive. It may be useful to provide improved anti-aliasing techniques.

Accordingly, the present embodiments are directed toward techniques for utilizing the graphics rendering pipeline 200 to perform anti-aliasing by encoding primitive edge representations. Specifically, in accordance with the presently disclosed embodiments, as opposed to utilizing MSAA or SSAA to perform anti-aliasing (e.g., which may be memory intensive and computationally expensive), the present embodiments may perform anti-aliasing by encoding a representation of each of the one or more edges of fragments passing through a pixel. In particular embodiments, the graphics rendering pipeline 200 may generate a number of fragments by rasterizing one or more primitives (e.g., triangles or other geometries) to be displayed by a set of pixels of the displays 114A, 114B. In particular embodiments, a pixel of the set of pixels may be associated with one or more fragments of a number of fragments, in which the one or more fragments may each include one or more edges covering at a least a portion of the pixel. In particular embodiments, the graphics rendering pipeline 200 may then encode each of the one or more fragments to include a representation of the one or more edges. In particular embodiments, the representation may include, for each of the one or more edges, (1) an orientation of the edge and (2) a pixel coverage associated with the edge. For example, in particular embodiments, the graphics rendering pipeline 200 may encode each of the one or more fragments to include the representation by encoding, for each of the one or more edges, one or more values specifying an uncorrelated pixel coverage associated with the edge.

In particular embodiments, the graphics rendering pipeline 200 may also encode each of the one or more fragments to include the representation by encoding, for each of the one or more edges, one or more values specifying a correlated pixel coverage associated with the edge. In particular embodiments, the graphics rendering pipeline 200 may further encode each of the one or more fragments to include the representation by encoding, for each of the one or more edges, one or more values specifying a correlated pixel coverage associated with the edge. In particular embodiments, the graphics rendering pipeline 200 may then determine one or more alpha values corresponding to the one or more fragments based on the orientation and the pixel coverage associated with each of the one or more edges. For example, in particular embodiments, the graphics rendering pipeline 200 may determine the one or more alpha values by determining a near alpha value and a far alpha value corresponding to the one or more fragments. In particular embodiments, the graphics rendering pipeline 200 may then generate a color value (e.g., (R)ed (G)reen (B)lue (A)lpha color value) for the pixel based on the one or more alpha values of the one or more fragments. For example, in particular embodiments, the graphics rendering pipeline 200 may generate the color value for the pixel by merging together at least a first fragment and a second fragment of the one or more fragments. In particular embodiments, the graphics rendering pipeline 200 may also generate the color value (e.g., one or more RGBA color values) for the pixel by blending a first color and a second color respectively associated with the one or more fragments.

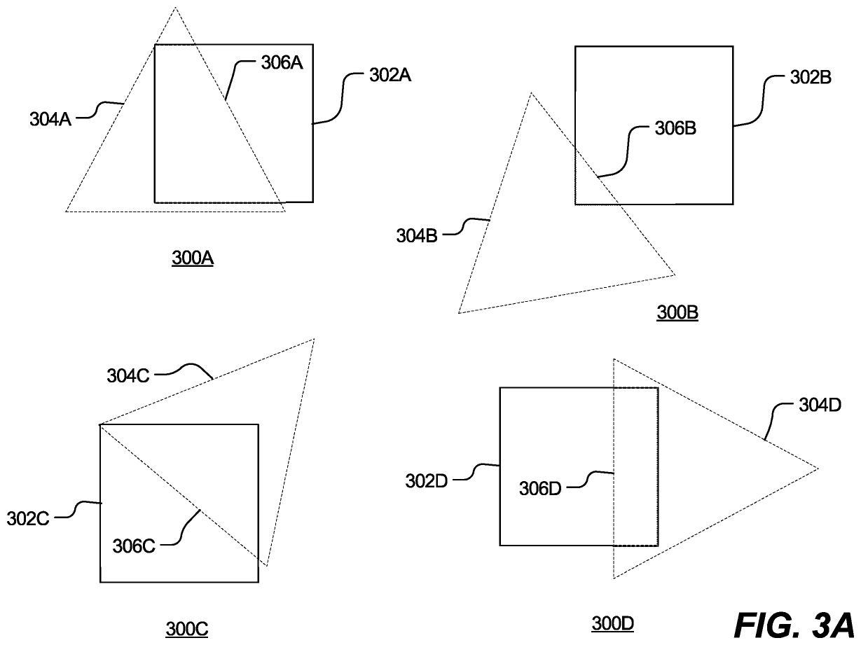

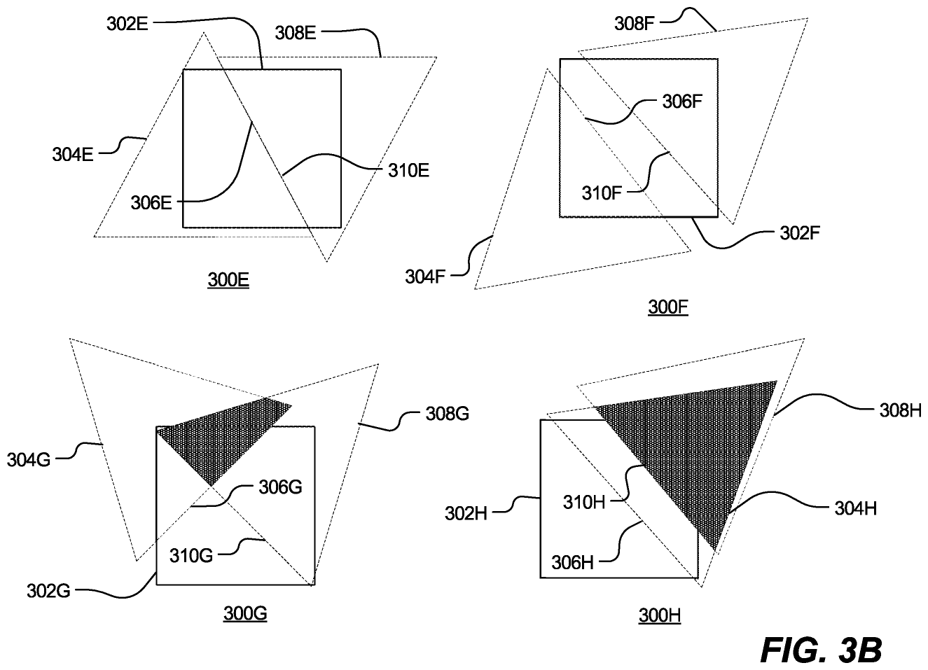

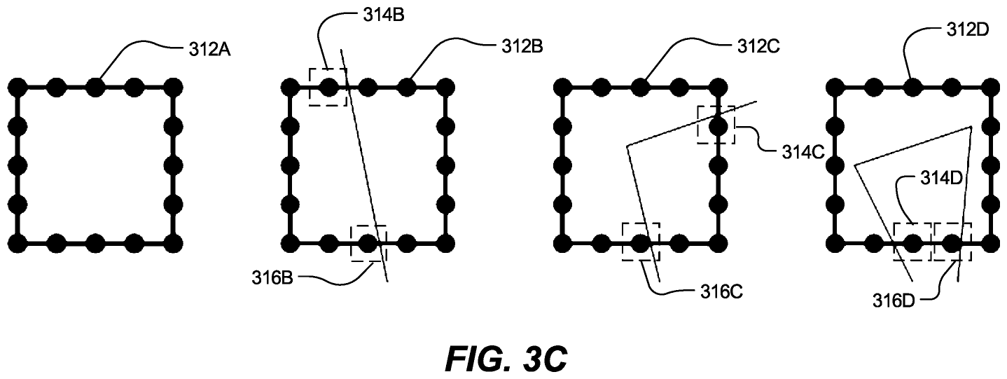

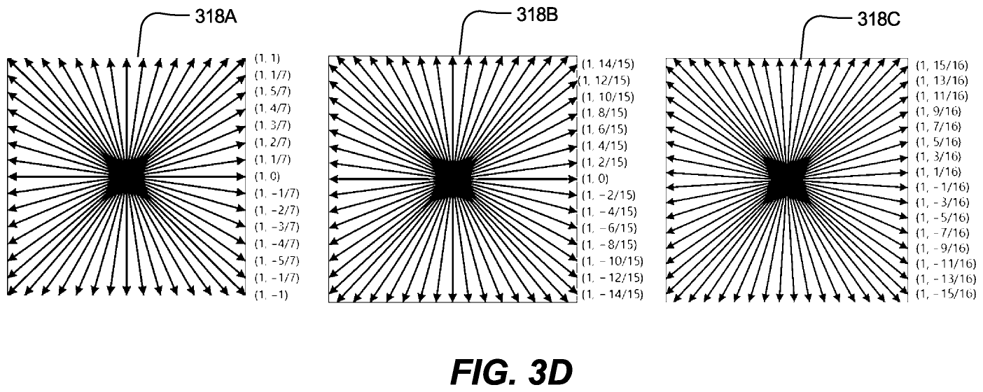

FIGS. 3A-3D illustrate one or more running examples of the present techniques for performing anti-aliasing by encoding primitive edge representations. For example, as will be discussed in further detail below, FIG. 3A illustrates one or more examples 300A-300D of primitive fragments 304A-304D (e.g., triangles or other geometries) that include singular edges 306A-306D that passes through pixels 302A-302D that may be blended based on, for example, one or more alpha values corresponding to the primitive fragments 304A-304D (e.g., triangles or other geometries) determined based on the edge normal and the pixel coverage associated with each of the one or more edges 306A-306D, in accordance with the primitive edge representation encoding techniques discussed herein. Similarly, as will be discussed in further detail below, FIG. 3B illustrates one or more examples 300E-300H of multiple primitive fragments 304E-304H, 308E-308H (e.g., triangles or other geometries) that each include edges 306E-306H, 310E-310H that pass through pixels 302E-302H that may be merged and/or blended based on, for example, one or more alpha values corresponding to the multiple primitive fragments 304E-304H, 308E-308H (e.g., triangles or other geometries) determined based on the edge normal and the pixel coverage associated with each of the one or more edges 306E-306H, 310E-310H, in accordance with the primitive edge representation encoding techniques discussed herein. Lastly, as will be discussed in further detail below, FIGS. 3C and 3D illustrate one or more running examples for estimating pixel coverage region by specifying the coarse intersection of the primitive fragments with the edges of the pixels 312A-312B and one or more running examples for specifying edge normals using signed N-bit coordinates, respectively.

Indeed, in particular embodiments, as previously noted, the graphics rendering pipeline 200 may perform rasterization of primitives (e.g., triangles or other geometries) to generate primitive fragments and rendering the primitive fragments 304E-304H, 308E-308H (e.g., triangles or other geometries) onto, for example, the pixels 302A-302D, 302E-302H. As may be appreciated, each pixel 302A-302D, 302E-302H may include any number of primitive fragments 304E-304H, 308E-308H (e.g., at varying distances), and thus each pixel 302A-302D, 302E-302H, for example, may include pixel multiple primitive fragments 304E-304H, 308E-308H (e.g., triangles or other geometries) that may pass through the respective pixels 302A-302D, 302E-302H. In accordance with the presently disclosed embodiments, each primitive fragment 304E-304H, 308E-308H (e.g., triangles or other geometries) may be encoded with information (e.g., a set of data values) that specifies the coverage of the associated primitive fragments 304E-304H, 308E-308H (e.g., triangles or other geometries) on the respective pixel 302A-302D, 302E-302H and the edge normal direction with respect to the one or more edges 306E-306H, 310E-310H that pass through the respective pixel 302A-302D, 302E-302H. For example, in particular embodiments, each respective primitive fragment 304E-304H, 308E-308H (e.g., triangles or other geometries) may be analyzed to determine whether the primitive fragment completely covers a respective pixel 302A-302D, 302E-302H, and, if so, then the respective primitive fragment 304E-304H, 308E-308H (e.g., triangles or other geometries) may be determined as not including any edges. On the hand, a single pixel 302A-302D, 302E-302H may include, for example, 1, 2, 3, or more edges 306A-306H, 310E-310H (e.g., as generally illustrated by running examples 300A-300D of FIG. 3A and running examples 300E-300H of FIG. 3B).

In particular embodiments, referring first to the one or more running examples 300A-300D of FIG. 3A, the respective primitive fragments 304A-304D (e.g., triangles or other geometries) include singular edges 306A-306D that passes through pixels 302A-302D. In accordance with the present primitive edge representation encoding techniques, respective representation of the singular edges 306A-306D may be encoded together with the primitive fragments 304A-304D (e.g., triangles or other geometries), in which the respective representation of the singular edges 306A-306D may include a normal vector of the respective edge 306A-306D and a pixel 302A-302D coverage associated with the respective edge 306A-306D. In particular embodiments, the graphics rendering pipeline 200 may then determine one or more alpha values corresponding to the respective primitive fragments 304A-304D (e.g., triangles or other geometries) based on the normal vector of the respective edge 306A-306D and a pixel 302A-302D coverage associated with the respective edge 306A-306D.

For example, in particular embodiments, the one or more alpha values specify the coverage of each respective pixel 302A-302D for purposes of merging and/or blending the respective edges 306A-306D of the primitive fragments 304A-304D (e.g., triangles or other geometries). In particular embodiments, the one or more alpha values may be further associated with the determined pixel coverage, which may include, for example, an uncorrelated coverage including coverage spread over the respective pixel 302A-302D (e.g., due to a semi-transparent primitive fragment 304A-304D), a correlated coverage including a specific pixel region covered (e.g., due to the edge of an opaque primitive fragment 304A-304D), and a semi-correlated coverage including some combination (e.g., due to the edge of a semi-transparent primitive fragment 304A-304D). In some embodiments, semi-correlated pixel coverage may be represented by providing both a correlated pixel coverage and an uncorrelated pixel coverage.

In particular embodiments, and as will be further appreciated with respect FIG. 3B, the one or more alpha values and the associated pixel coverage classification (e.g., uncorrelated coverage, correlated coverage, semi-correlated coverage) may be determined for purposes of merging and/or blending the respective edges 306A-306D of the primitive fragments 304A-304D (e.g., triangles or other geometries). In particular embodiments, the difference between correlated coverage alpha and uncorrelated coverage alpha may be suitable when, for example, two or more partially covered primitive fragments 304E-304H, 308E-308H are merged and/or blended. For example, the extent to which the pixel coverage is determined as being correlated or uncorrelated may affect the manner in which the primitive fragments 304E-304H, 308E-308H may be suitably merged and/or blended. For example, in particular embodiments, for correlated coverage primitive fragments 304E-304H, 308E-308H, the graphics rendering pipeline 200 may determine one or more alpha values for a predetermined number of different correlated coverage cases for primitive fragments 304E-304H, 308E-308H with coverage regions near alpha (e.g., “Na”) and far alpha (e.g., “Fa”).

For example, in particular embodiments, as illustrated by running example 300E of FIG. 3B, for the correlated coverage case in which the union (e.g., AUB) of the primitive fragment 304E and the primitive fragment 308E covers the entire pixel 302E, the far blend coverage alpha may be determined as: min(Fa, 1−Na)=1−Na. In particular embodiments, as illustrated by running example 300F of FIG. 3B, for the correlated coverage case in which the intersection (e.g., A∩B) of the primitive fragment 304F and the primitive fragment 308F is “0” (e.g., the primitive fragment 304F and the primitive fragment 308F do not overlap) for the pixel 302F, the far blend coverage alpha may be determined as: min(Fa, 1−Na)=Fa. Further, in particular embodiments, for the correlated coverage case in which the subsets (e.g., A−B or B−A) of the primitive fragment 304F and the primitive fragment 308F is “0” (e.g., subsets of the primitive fragment 304F and the primitive fragment 308F are empty), the far blend coverage alpha may be determined as: max(Fa−Na, 0). Finally, in particular embodiments, as illustrated by the running examples 300G and 300H, for the correlated coverage case in which the subsets (e.g., A−B or B−A) of the primitive fragment 304F and the primitive fragment 308F is nonzero (e.g., subsets of the primitive fragment 304F and the primitive fragment 308F are non-empty), the far blend coverage alpha may be determined as falling between, for example, max(Fa−Na, 0) and min(Fa, 1−Na)=1−Na.

In particular embodiments, based on the one or more alpha values and the associated pixel coverage classification (e.g., uncorrelated coverage, correlated coverage, semi-correlated coverage), the graphics rendering pipeline 200 may perform a merging of a two or more primitive fragments 304E-304H, 308E-308H and/or a blending by generating a color value (e.g., one or more RGBA color values) for the pixel values of the one or more primitive fragments 304E-304H, 308E-308H. For example, in particular embodiments, the primitive fragments 304E and 308E of running example 300A may be merged together. For example, in particular embodiments, the pixel 302E may include multiple primitive fragments 304E and 308E stacked atop of each other. In particular embodiments, for example, as when the edges 306E, 310E of the respective primitive fragments 304E and 308H of running example 300A are abutting, the primitive fragments 304E and 308H may be merged together to reduce or eliminate potential aliasing artifacts. In particular embodiments, alternatively, or in addition to the aforementioned, the graphics rendering pipeline 200 may expressly tag (e.g., utilizing a unique identifiers), for example, the primitive fragments 304E and 308H as being able to be merged. It should be appreciated that 304E may 308E may represent, for example, an example case in which merging may occur prior to shading, for example, if the triangles use the same shading function.

In particular embodiments, the running examples 300F, 300G, and 300H may include examples of primitive fragments that may be blended to reduce or eliminate potential aliasing artifacts. For example, as previously discussed above, to compute the proper blending, the graphics rendering pipeline 200 may deploy one or more predetermined rules (e.g., bright-line rules) to compute the number of blending cases (e.g., parallel or orthogonal edges 306F and 310F; 306G and 310G; and 306H and 310H), and, if the respective edges are less than 90 degs, the graphics rendering pipeline 200 may interpolate the coverage results from the parallel and orthogonal cases. For example, as depicted by running example 300F, because the respective edges 306F and 310F are oriented parallel and in opposite directions, the graphics rendering pipeline 200 may utilize min(Fa, 1-Na) as pixel coverage and the final far alpha Fa=Fa. Similarly, as depicted by running example 300G, because the respective edges 306G and 310G are oriented orthogonal, the graphics rendering pipeline 200 may utilize Na*Fa as the pixel coverage and the final far alpha Fa=Na*Fa. Likewise, as depicted by running example 300F, because the respective edges 306H and 310H are oriented parallel and in the same direction, the graphics rendering pipeline 200 may utilize max(0, Fa−Na) as the pixel coverage and the final far alpha Fa=Fa−Na. For all other cases, the graphics rendering pipeline 200 may blend, for example, blend starting with Na*Fa toward either Fa=Fa and/or Fa=Fa−Na.

In particular embodiments, FIG. 3C illustrates one or more running examples for estimating the correlated coverage region by specifying the coarse intersection of a primitive with fragment edges of the pixel grid square. In particular embodiments, as discussed above, one or more alpha values may be determined to specify the pixel grid 312A-312D coverage. For example, in particular embodiments, the pixel grid 312A may include 16 positions marked around the perimeter. The pixel grid 312B shows a single fragment edge crossing the pixel grid 312B square at intersection points 314B, 316B after rounding the intersection points 314B, 316B to the nearest perimeter position. The pixel grid 312C shows two fragment edges meeting at a vertex in the pixel grid 312C, and the pixel grid 312D case where two primitive vertices fall within the triangle, but there are still two intersection points 314D, 316D with the pixel grid 312D.

In particular embodiments, FIG. 3D illustrates one or more running examples 318A-318C of the previous discuss techniques of utilizing one or more alpha values to encode an amount of coverage, and utilizing a separate field to specify the orientation of the edge. In particular embodiments, as previously discussed above, each edge normal vector may be utilized solely to determine how to blend correlated primitive fragments. For example, in particular embodiments, the graphics rendering pipeline 200 may compute a dot product of the edge normals for each of primitive fragments and determining one of several blending cases. For example, if the dot product is “−1”, the edges of the primitive fragments are parallel and opposite, and thus the disjoint blending technique may be deployed by the graphics rendering pipeline 200. Continuing, if the dot product is “+1”, the edges of each primitive fragment are parallel and in the same direction, then the subset blending technique may be deployed by the graphics rendering pipeline 200. Lastly, for intermediate dot product values, the graphics rendering pipeline 200 may perform linear interpolation with respect the to the disjoint and subset blending techniques.

In particular embodiments, while the edge normal may be specified in terms of angle, for example, angles may not allow for mixing correlated and uncorrelated alpha in the same coverage alpha. Thus, in particular embodiments, the present embodiments may include a technique that overcomes the aforementioned by storing an (x, y) vector (e.g., with as few as 4-bits per signed value). In particular embodiments, the (x, y) vector may be computed from a primitive edge, but may also be computed by gradient filtering an array of alpha values (e.g., the x term may be computed by the filter (−1,0,1) and they term may utilize the filter (−1,0,1)^{T}). In particular embodiments, if the alpha is computed as being constant over a region, the result of the gradient filter is (0,0). This may be interpreted as alpha being entirely uncorrelated. On the other hand, if one of the coordinates is ±1, alpha may be interpreted as being entirely correlated. In this way, the one or more running examples 318A-318C illustrate three ways to specify edge normals utilizing, for example, signed 4-bit coordinates.

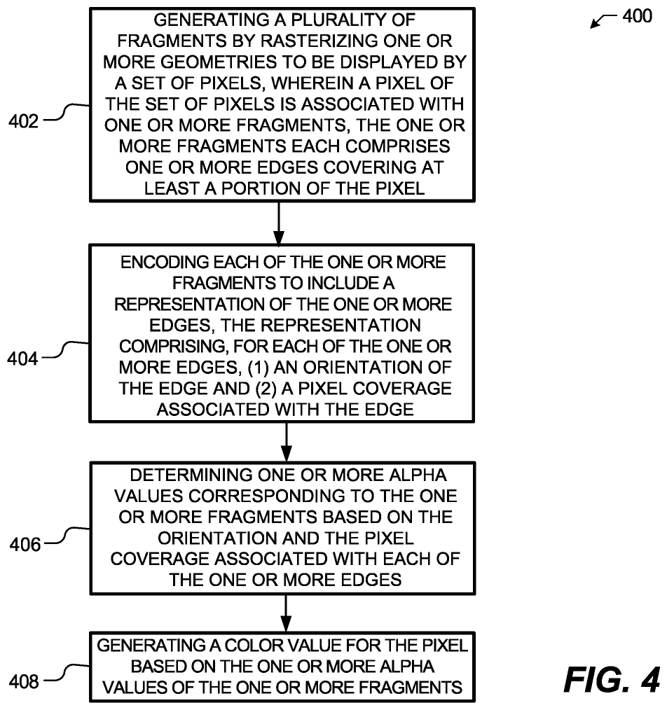

FIG. 4 illustrates a flow diagram of a method 400 for performing anti-aliasing by encoding primitive edge representations, in accordance with presently disclosed techniques. The method 400 may be performed utilizing one or more processing devices (e.g., XR device 102) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 400 may begin at block 402 with one or more processing devices (e.g., XR device 102) generating a plurality of fragments by rasterizing one or more geometries to be displayed by a set of pixels, in which a pixel of the set of pixels is associated with one or more fragments of the plurality of fragments and the one or more fragments each includes one or more edges covering at a least a portion of the pixel. The method 400 may then continue at block 404 with the one or more processing devices (e.g., graphics pipeline 200) encoding each of the one or more fragments to include a representation of the one or more edges, the representation comprising, for each of the one or more edges, (1) an orientation of the edge and (2) a pixel coverage associated with the edge. The method 400 may then continue at block 406 with the one or more processing devices (e.g., graphics pipeline 200) determining one or more alpha values corresponding to the one or more fragments based on the orientation and the pixel coverage associated with each of the one or more edges. The method 400 may then conclude at block 408 with the one or more processing devices (e.g., graphics pipeline 200) generating a color value for the pixel based on the one or more alpha values of the one or more fragments. For example, generating a color value for the pixel based on the one or more alpha values of the one or more fragments may include, for example, merging some cases and then shading, and then performing more merging and blending, for example.

Accordingly, as described by the method 400 of FIG. 4, the present embodiments are directed toward techniques for performing anti-aliasing by encoding primitive edge representations, in accordance with presently disclosed embodiments. In particular embodiments, a computing system of a device may generate a number of fragments by rasterizing one or more geometries to be displayed by a set of pixels. In particular embodiments, a pixel of the set of pixels may be associated with one or more fragments of the plurality of fragments, in which the one or more fragments may each include one or more edges covering at a least a portion of the pixel. In particular embodiments, the computing system of the device may then encode each of the one or more fragments to include a representation of the one or more edges. In particular embodiments, the representation may include, for each of the one or more edges, (1) an orientation of the edge and (2) a pixel coverage associated with the edge. For example, in particular embodiments, the computing system of the device may encode each of the one or more fragments to include the representation by encoding, for each of the one or more edges, one or more values specifying an uncorrelated pixel coverage associated with the edge.

In particular embodiments, the computing system of the device may also encode each of the one or more fragments to include the representation by encoding, for each of the one or more edges, one or more values specifying a correlated pixel coverage associated with the edge. In particular embodiments, the computing system of the device may further encode each of the one or more fragments to include the representation by encoding, for each of the one or more edges, one or more values specifying a correlated pixel coverage associated with the edge. In particular embodiments, the computing system of the device may then determine one or more alpha values corresponding to the one or more fragments based on the orientation and the pixel coverage associated with each of the one or more edges. For example, in particular embodiments, the computing system of the device may determine the one or more alpha values by determining a near alpha value and a far alpha value corresponding to the one or more fragments. In particular embodiments, the computing system of the device may then generate a color value for the pixel based on the one or more alpha values of the one or more fragments. For example, in particular embodiments, the computing system of the device may generate the color value for the pixel by merging together at least a first fragment and a second fragment of the one or more fragments. In particular embodiments, the computing system of the device may also generate the color value for the pixel by blending a first color and a second color respectively associated with the one or more fragments. Thus, in accordance with the foregoing embodiments, the present embodiments may provide techniques for performing anti-aliasing by encoding primitive edge representations. Indeed, the present embodiments may provide techniques to perform efficient anti-aliasing by storing a simplified representation of the primitive fragment edges that pass through a pixel while also reducing impact processing and memory resources.

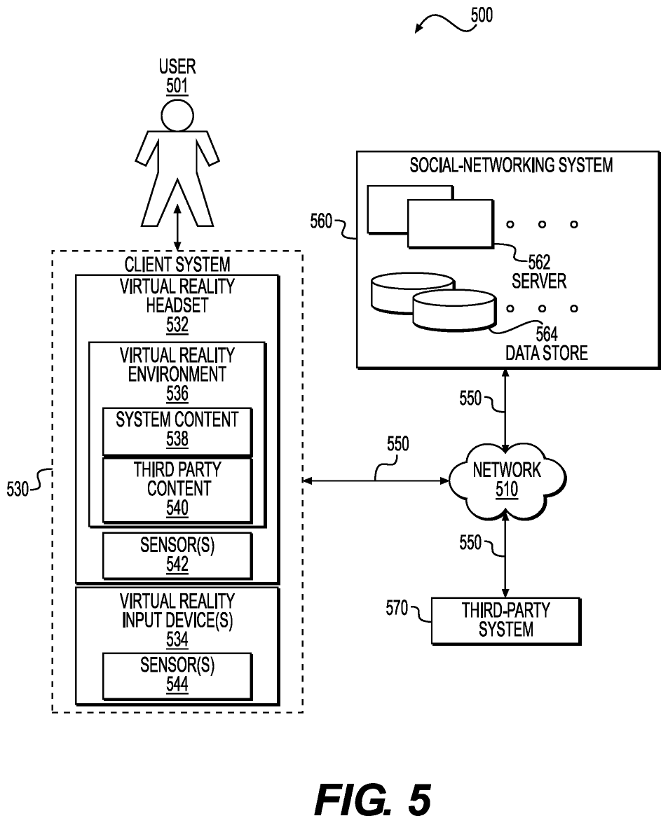

FIG. 5 illustrates an example network environment 500 associated with an extended reality (XR) system. Network environment 500 includes a user 501 interacting with a client system 530, a social-networking system 560, and a third-party system 570 connected to each other by a network 510. Although FIG. 5 illustrates a particular arrangement of a user 501, a client system 530, a social-networking system 560, a third-party system 570, and a network 510, this disclosure contemplates any suitable arrangement of a user 501, a client system 530, a social-networking system 560, a third-party system 570, and a network 510. As an example, and not by way of limitation, two or more of users 501, a client system 530, a social-networking system 560, and a third-party system 570 may be connected to each other directly, bypassing a network 510. As another example, two or more of client systems 530, a social-networking system 560, and a third-party system 570 may be physically or logically co-located with each other in whole or in part. Moreover, although FIG. 5 illustrates a particular number of users 501, client systems 530, social-networking systems 560, third-party systems 570, and networks 510, this disclosure contemplates any suitable number of client systems 530, social-networking systems 560, third-party systems 570, and networks 510. As an example, and not by way of limitation, network environment 500 may include multiple users 501, client systems 530, social-networking systems 560, third-party systems 570, and networks 510.

This disclosure contemplates any suitable network 510. As an example, and not by way of limitation, one or more portions of a network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 510 may include one or more networks 510. Links 550 may connect a client system 530, a social-networking system 560, and a third-party system 570 to a communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout a network environment 500. One or more first links 550 may differ in one or more respects from one or more second links 550.

In particular embodiments, a client system 530 may be an electronic device including hardware, software, or embedded logic components or a combination of two or more such components and capable of carrying out the appropriate functionalities implemented or supported by a client system 530. As an example, and not by way of limitation, a client system 530 may include a computer system such as a desktop computer, notebook or laptop computer, netbook, a tablet computer, e-book reader, GPS device, camera, a digital assistant (PDA), handheld electronic device, cellular telephone, smartphone, virtual reality headset and controllers, other suitable electronic device, or any suitable combination thereof. This disclosure contemplates any suitable client systems 530. A client system 530 may enable a network user at a client system 530 to access a network 510. A client system 530 may enable its user to communicate with other users at other client systems 530. A client system 530 may generate a virtual reality environment for a user to interact with content.

In particular embodiments, a client system 530 may include a virtual reality (or augmented reality) headset 532, and virtual reality input device(s) 534, such as a virtual reality controller. A user at a client system 530 may wear the virtual reality headset 532 and use the virtual reality input device(s) to interact with a virtual reality environment 536 generated by the virtual reality headset 532. Although not shown, a client system 530 may also include a separate processing computer and/or any other component of a virtual reality system. A virtual reality headset 532 may generate a virtual reality environment 536, which may include system content 538 (including but not limited to the operating system), such as software or firmware updates and also include third-party content 540, such as content from applications or dynamically downloaded from the Internet (e.g., web page content). A virtual reality headset 532 may include sensor(s) 542, such as accelerometers, gyroscopes, magnetometers to generate sensor data that tracks the location of the headset device 532. The headset 532 may also include eye trackers for tracking the position of the user's eyes or their viewing directions. The client system may use data from the sensor(s) 542 to determine velocity, orientation, and gravitation forces with respect to the headset.

Virtual reality input device(s) 534 may include sensor(s) 544, such as accelerometers, gyroscopes, magnetometers, and touch sensors to generate sensor data that tracks the location of the input device 534 and the positions of the user's fingers. The client system 530 may make use of outside-in tracking, in which a tracking camera (not shown) is placed external to the virtual reality headset 532 and within the line of sight of the virtual reality headset 532. In outside-in tracking, the tracking camera may track the location of the virtual reality headset 532 (e.g., by tracking one or more infrared LED markers on the virtual reality headset 532). Alternatively, or additionally, the client system 530 may make use of inside-out tracking, in which a tracking camera (not shown) may be placed on or within the virtual reality headset 532 itself. In inside-out tracking, the tracking camera may capture images around it in the real world and may use the changing perspectives of the real world to determine its own position in space.

Third-party content 540 may include a web browser, such as MICROSOFT INTERNET EXPLORER, GOOGLE CHROME or MOZILLA FIREFOX, and may have one or more add-ons, plug-ins, or other extensions, such as TOOLBXR or YAHOO TOOLBXR. A user at a client system 530 may enter a Uniform Resource Locator (URL) or other address directing a web browser to a particular server (such as server 562, or a server associated with a third-party system 570), and the web browser may generate a Hyper Text Transfer Protocol (HTTP) request and communicate the HTTP request to server. The server may accept the HTTP request and communicate to a client system 530 one or more Hyper Text Markup Language (HTML) files responsive to the HTTP request. The client system 530 may render a web interface (e.g. a webpage) based on the HTML files from the server for presentation to the user. This disclosure contemplates any suitable source files. As an example, and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 560 may be a network-addressable computing system that may host an online social network. The social-networking system 560 may generate, store, receive, and send social-networking data, such as, for example, user-profile data, concept-profile data, social-graph information, or other suitable data related to the online social network. The social-networking system 560 may be accessed by the other components of network environment 500 either directly or via a network 510. As an example, and not by way of limitation, a client system 530 may access the social-networking system 560 using a web browser of a third-party content 540, or a native application associated with the social-networking system 560 (e.g., a mobile social-networking application, a messaging application, another suitable application, or any combination thereof) either directly or via a network 510. In particular embodiments, the social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof.

In particular embodiments, each server 562 may include hardware, software, or embedded logic components or a combination of two or more such components for carrying out the appropriate functionalities implemented or supported by server 562. In particular embodiments, the social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, the social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. The social-networking system 560 may provide users of the online social network the ability to communicate and interact with other users. In particular embodiments, users may join the online social network via the social-networking system 560 and then add connections (e.g., relationships) to a number of other users of the social-networking system 560 whom they want to be connected to. Herein, the term “friend” may refer to any other user of the social-networking system 560 with whom a user has formed a connection, association, or relationship via the social-networking system 560.

In particular embodiments, the social-networking system 560 may provide users with the ability to take actions on various types of items or objects, supported by the social-networking system 560. As an example, and not by way of limitation, the items and objects may include groups or social networks to which users of the social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 560 or by an external system of a third-party system 570, which is separate from the social-networking system 560 and coupled to the social-networking system 560 via a network 510.

In particular embodiments, the social-networking system 560 may be capable of linking a variety of entities. As an example, and not by way of limitation, the social-networking system 560 may enable users to interact with each other as well as receive content from third-party systems 570 or other entities, or to allow users to interact with these entities through an application programming interfaces (API) or other communication channels. In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating the social-networking system 560. In particular embodiments, however, the social-networking system 560 and third-party systems 570 may operate in conjunction with each other to provide social-networking services to users of the social-networking system 560 or third-party systems 570. In this sense, the social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example, and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 560 also includes user-generated content objects, which may enhance a user's interactions with the social-networking system 560. User-generated content may include anything a user may add, upload, send, or “post” to the social-networking system 560. As an example, and not by way of limitation, a user communicates posts to the social-networking system 560 from a client system 530. Posts may include data such as status updates or other textual data, location information, photos, videos, links, music or other similar data or media. Content may also be added to the social-networking system 560 by a third-party through a “communication channel,” such as a newsfeed or stream. In particular embodiments, the social-networking system 560 may include a variety of servers, sub-systems, programs, modules, logs, and data stores. In particular embodiments, the social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 560 may also include suitable components such as network interfaces, security mechanisms, load balancers, failover servers, management-and-network-operations consoles, other suitable components, or any suitable combination thereof.

In particular embodiments, the social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example, and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 560 to one or more client systems 530 or one or more third-party systems 570 via a network 510. The web server may include a mail server or other messaging functionality for receiving and routing messages between the social-networking system 560 and one or more client systems 530. An API-request server may allow a third-party system 570 to access information from the social-networking system 560 by calling one or more APIs. An action logger may be used to receive communications from a web server about a user's actions on or off the social-networking system 560.

In conjunction with the action log, a third-party-content-object log may be maintained of user exposures to third-party-content objects. A notification controller may provide information regarding content objects to a client system 530. Information may be pushed to a client system 530 as notifications, or information may be pulled from a client system 530 responsive to a request received from a client system 530. Authorization servers may be used to enforce one or more privacy settings of the users of the social-networking system 560. A privacy setting of a user may determine how particular information associated with a user may be shared. The authorization server may allow users to opt in to or opt out of having their actions logged by the social-networking system 560 or shared with other systems (e.g., a third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

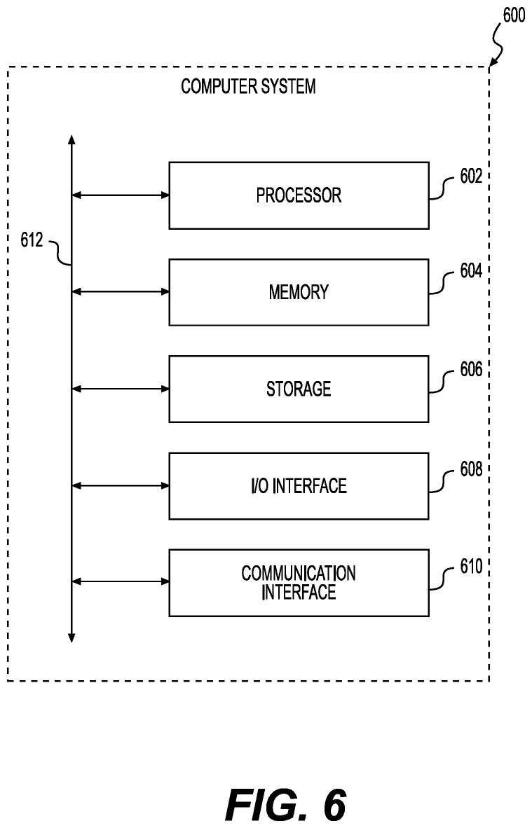

FIG. 6 illustrates an example computer system 600 that may be useful in performing one or more of the foregoing techniques as presently disclosed herein. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein.

As an example, and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate. In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602.

Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere).

One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EXROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a user and computer system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 610 for it.

As an example, and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example, and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a user having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a user having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising, by a computing system of a device:
generating a plurality of fragments by rasterizing one or more geometries to be displayed by a set of pixels, wherein a pixel of the set of pixels is associated with one or more fragments of the plurality of fragments, the one or more fragments each comprises one or more edges covering at a least a portion of the pixel;
encoding each of the one or more fragments to include a representation of the one or more edges, the representation comprising, for each of the one or more edges, (1) an orientation of the edge and (2) a pixel coverage associated with the edge;
determining one or more alpha values corresponding to the one or more fragments based on the orientation and the pixel coverage associated with each of the one or more edges; and
generating a color value for the pixel based on the one or more alpha values corresponding to the one or more fragments.

2. The method of claim 1, wherein encoding each of the one or more fragments to include the representation comprises encoding, for each of the one or more edges, one or more values specifying an uncorrelated pixel coverage associated with the edge.

3. The method of claim 1, wherein encoding each of the one or more fragments to include the representation comprises encoding, for each of the one or more edges, one or more values specifying a correlated pixel coverage associated with the edge.

4. The method of claim 1, wherein encoding each of the one or more fragments to include the representation comprises encoding, for each of the one or more edges, a normal vector specifying the orientation of the edge.

5. The method of claim 1, wherein determining the one or more alpha values comprises determining a near alpha value and a far alpha value corresponding to the one or more fragments.

6. The method of claim 1, wherein generating the color value for the pixel comprises merging together at least a first fragment and a second fragment of the one or more fragments.

7. The method of claim 1, wherein generating the color value for the pixel comprises blending a first color and a second color respectively associated with the one or more fragments.

8. A computing device, comprising:
a non-transitory computer-readable storage medium including instructions; and
one or more processors coupled to the non-transitory computer-readable storage medium, the one or more processors configured to execute the instructions to:
generate a plurality of fragments by rasterizing one or more geometries to be displayed by a set of pixels, wherein a pixel of the set of pixels is associated with one or more fragments of the plurality of fragments, the one or more fragments each comprises one or more edges covering at a least a portion of the pixel;
encode each of the one or more fragments to include a representation of the one or more edges, the representation comprising, for each of the one or more edges, (1) an orientation of the edge and (2) a pixel coverage associated with the edge;
determine one or more alpha values corresponding to the one or more fragments based on the orientation and the pixel coverage associated with each of the one or more edges; and
generate a color value for the pixel based on the one or more alpha values corresponding to the one or more fragments.

9. The computing device of claim 8, wherein the instructions to encode each of the one or more fragments to include the representation further comprise instructions to encode, for each of the one or more edges, one or more values specifying an uncorrelated pixel coverage associated with the edge.

10. The computing device of claim 8, wherein the instructions to encode each of the one or more fragments to include the representation further comprise instructions to encode, for each of the one or more edges, one or more values specifying a correlated pixel coverage associated with the edge.

11. The computing device of claim 8, wherein the instructions to encode each of the one or more fragments to include the representation further comprise instructions to encode, for each of the one or more edges, a normal vector specifying the orientation of the edge.

12. The computing device of claim 8, wherein the instructions to determine the one or more alpha values further comprise instructions to determine a near alpha value and a far alpha value corresponding to the one or more fragments.

13. The computing device of claim 8, wherein the instructions to generate the color value for the pixel further comprise instructions to merge together at least a first fragment and a second fragment of the one or more fragments.

14. The computing device of claim 8, wherein the instructions to generate the color value for the pixel further comprise instructions to blend a first color and a second color respectively associated with the one or more fragments.

15. A non-transitory computer-readable medium comprising instructions that, when executed by one or more processors of a device, cause the one or more processors to:
generate a plurality of fragments by rasterizing one or more geometries to be displayed by a set of pixels, wherein a pixel of the set of pixels is associated with one or more fragments of the plurality of fragments, the one or more fragments each comprises one or more edges covering at a least a portion of the pixel;
encode each of the one or more fragments to include a representation of the one or more edges, the representation comprising, for each of the one or more edges, (1) an orientation of the edge and (2) a pixel coverage associated with the edge;
determine one or more alpha values corresponding to the one or more fragments based on the orientation and the pixel coverage associated with each of the one or more edges; and
generate a color value for the pixel based on the one or more alpha values corresponding to the one or more fragments.

16. The non-transitory computer-readable medium of claim 15, wherein the instructions to encode each of the one or more fragments to include the representation further comprise instructions to encode, for each of the one or more edges, one or more values specifying an uncorrelated pixel coverage associated with the edge.

17. The non-transitory computer-readable medium of claim 15, wherein the instructions to encode each of the one or more fragments to include the representation further comprise instructions to encode, for each of the one or more edges, one or more values specifying a correlated pixel coverage associated with the edge.

18. The non-transitory computer-readable medium of claim 15, wherein the instructions to encode each of the one or more fragments to include the representation further comprise instructions to encode, for each of the one or more edges, a normal vector specifying the orientation of the edge.

19. The non-transitory computer-readable medium of claim 15, wherein the instructions to determine the one or more alpha values further comprise instructions to determine a near alpha value and a far alpha value corresponding to the one or more fragments.

20. The non-transitory computer-readable medium of claim 15, wherein the instructions to generate the color value for the pixel further comprise instructions to blend a first color and a second color respectively associated with the one or more fragments.
